(19) United States
(12) Patent Application Publication
(10) Pub. No.: US 2011/0052028 A1
(43) Pub. Date: Mar. 3, 2011

(54) METHOD AND SYSTEM OF LIVER SEGMENTATION

(75) Inventor: Reuven SHREIBER, Haifa (IL)

(73) Assignee: Algotec Systems Ltd., RaAnana (IL)

(21) Appl. No.: 12/868,770

(22) Filed: Aug. 26, 2010

Related U.S. Application Data
(60) Provisional application No. 61/236,897, filed on Aug. 26, 2009.

(51) Int. Cl. G06K 9/00

(52) U.S. Cl. 382/131; 382/128

(57) ABSTRACT

A method for segmenting liver parenchyma in a medical image. The method comprises receiving a medical image depicting the liver parenchyma, separating the liver parenchyma from in the medical image, and segmenting the depicted liver parenchyma to functionally independent liver segments.

### RELATED APPLICATIONS

This application claims the benefit of priority under 35 USC 119(e) of U.S. Provisional Patent Application No. 61/236,897 filed Aug. 26, 2009, the contents of which are incorporated herein by reference in their entirety.

The teachings of U.S. Provisional Patent Application No. 61/179,386 filed on May 19, 2009, are also incorporated by reference as if fully set forth herein.

### FIELD AND BACKGROUND OF THE INVENTION

The present invention, in some embodiments thereof, relates to a method and system of organ segmentation and, more particularly, but not exclusively, to a method and system of liver segmentation.

As commonly known, liver vasculature is highly variable, and it may be useful to have a 3D model of the liver and vasculature for patients considered for hepatic surgery. For example, when a liver resection is needed for removal of one or more tumors, it is important to accurately determine the tumors' location in relation to the hepatic vessels.

The Couinaud classification of liver anatomy divides the liver into eight functionally independent liver segments. Each segment has a separable vascular inflow, a separable vascular outflow, and biliary outflow. Liver resections follow the hepatic veins to preserve venous outflow and the portal veins and hepatic arteries to provide vascular inflow. Furthermore, bile ducts provide the biliary outflow. Segmentation of the liver from other organs is also used for radiologic interpretation and description of the location of lesions and follow-up.

During the last few years various methods have been developed for automatically segmenting the liver. For example, Toshiyuki Okada at. el., “Automated Segmentation of the Liver from 3D CT Images Using Probabilistic Atlas and Multi-level Statistical Shape Model”, Osaka University Graduate School of Medicine, Suita, Osaka, 565-0871, Japan, which is available at http://www.image.med.osakau.ac.jp/publications/MICCAI2007_Okada.pdf, describes an atlas-based automated liver segmentation method from three dimensional (3D) computerized tomography (CT) images. The method utilizes two types of atlases, that is, the probabilistic atlas (PA) and statistical shape model (SSM). Voxel-based segmentation with PA is firstly performed to obtain a liver region, and then the obtained region is used as the initial region for subsequent SSM fitting to 3D CT images. To improve reconstruction accuracy especially for highly deformed livers, a multi-level SSM (ML-SSM) is utilized. In ML-SSM, the whole shape is divided into patches, and principal component analysis is applied to each of the patches. To avoid inconsistency among the patches, a new constraint is introduced, called the adhesiveness constraint for overlap regions among patches.

Another method is disclosed in U.S. Patent Application Pub. No. 2009/0097726, published on Apr. 16, 2009, that describes a system, a method, and apparatus for automatic segmentation of a liver parenchyma from multiphase contrast-enhanced computed-tomography images. The method includes analyzing an intensity change in the images belonging to the different phases in order to determine the region-of-interest of the liver, thereafter segmenting starting from the region-of-interest and incorporating anatomical information to prevent oversegmentation, and thereafter combining the information of all available images.

### SUMMARY OF THE INVENTION

According to some embodiments of the present invention there is provided a method for segmenting liver parenchyma in a medical image. The method comprises a) receiving a medical image depicting the liver parenchyma, b) separating the liver parenchyma from at least one object depicted in the medical image, and c) segmenting the depicted liver parenchyma to a plurality of functionally independent liver segments.

Optionally, the method comprises computing a plurality of planes passing through the liver parenchyma, the segmenting being performed according to the plurality of planes.

More optionally, the segmenting is performed automatically according to the plurality of planes.

More optionally, the computing comprises 1) identifying a latitudinal plane passing through a bifurcation of the liver parenchyma, 2) identifying three vertical planes each passing through an axis traversing the inferior vena cava (IVC) and one of the Intrahepatic main hepatic veins, and 3) identifying an additional plane passing through the axis and the bifurcation; the segmenting is performed according to a combination of the latitudinal plane, the three vertical planes, and the additional plane.

More optionally, the automatically identifying comprises allowing a user to mark at least one point on the bifurcation using a user interface and performing the identifying according to the at least one point.

More optionally, 1) comprises allowing a user to mark at least one point on the bifurcation using a user interface and performing the identifying according to the at least one point.

More optionally, the computing comprises segmenting at least a portion of a plexus of vessels of the intrahepatic portal system of the liver parenchyma and identifying at least one of the plurality of planes according to the portion.

More optionally, the computing is performed automatically.

Optionally, the method comprises allowing a user to refine the segmenting using a user interface.

Optionally, the medical image is selected from a group consisting of a computed tomography (CT) scan object, a positron emission tomography (PET)/CT scan object, and a digital imaging and communications in medicine (DICOM) object.

Optionally, the method comprises presenting the functionally independent liver segments.

Optionally, the method comprises forwarding the functionally independent liver segments to a computing unit to allow a diagnosis of at least one of the functionally independent liver segments.

Optionally, the method comprises identifying a pathological region in the liver parenchyma and associating the pathological region with at least one of the functionally independent liver segments.

In some embodiments of the invention, the method further comprises receiving at least one additional medical image depicting the liver parenchyma, and separating the liver parenchyma, or segmenting the liver parenchyma into functionally independent liver segments, or both, is done using data from more than one of the medical images.

Optionally, at least two of the medical images are acquired at different times.

Optionally, at least two of the medical images are acquired at different phases of a same study of the liver.

Additionally or alteratively, at least two of the medical images are acquired in different studies of the liver of a same patient.

Optionally, at least two of the medical images are made using different modalities.

Optionally, at least one of the medical images is a CT image.

Additionally or alternatively, at least one of the medical images is an MRI image.

Optionally, the method also includes registering the medical image to the at least one additional medical image, before at least one of separating the liver parenchyma and segmenting the liver parenchyma into functionally independent segments.

According to some embodiments of the present invention there is provided an apparatus for segmenting liver parenchyma in a medical image. The apparatus comprises an input interface for receiving a medical image depicting the liver parenchyma and a segmentation module for computing a segmentation of the depicted liver parenchyma to a plurality of functionally independent liver segments.

Optionally, the segmentation module is configured for identifying a plurality of planes passing through the depicted liver and performing the segmentation according to the plurality of planes.

Optionally, the apparatus comprises a user interface for allowing a user to refine the segmenting.

Optionally, the apparatus comprises a user interface for allowing a user to mark at least one reference point on the liver parenchyma, the segmentation module configured for receiving the at least one reference point and generating the segmentation accordingly.

Optionally, the input interface is configured for receiving the medical image from an archiving communication system (PACS).

Optionally, the medical image is selected from a group consisting of a computed tomography (CT) scan object, a positron emission tomography (PET)/CT scan object, and a digital imaging and communications in medicine (DICOM) object.

Optionally, the apparatus comprises an output unit for separately outputting at least one of the functionally independent liver segments.

Optionally, the segmentation module separates the liver parenchyma from at least one object depicted in the medical image and performing the identification accordingly.

Optionally, the segmentation module segments at least a portion of a plexus of vessels of the intrahepatic portal system of the liver parenchyma and performing the identification accordingly.

Optionally, the input interface is configured for receiving the medical image from a remote terminal via a communication network.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart a method for segmenting the liver in a medical image according to a plurality of functionally independent liver segments, according to some embodiments of the present invention;

FIG. 2 is a schematic illustration of functionally independent liver segments of the liver, optionally as defined according to Couinaud classification;

FIG. 3 is a flowchart of a process for defining the intrahepatic portal system, according to some embodiments of the present invention;

FIG. 4 is a flowchart of a method for identifying the vertical planes in the liver, according to some embodiments of the present invention; and

FIG. 5 is a schematic illustration of an apparatus, connected to a communication network, for segmenting the liver in medical studies to a plurality of functionally independent liver segments, according to some embodiments of the present invention.

### DESCRIPTION OF EMBODIMENTS OF THE INVENTION

The present invention, in some embodiments thereof, relates to a method and system of organ segmentation and, more particularly, but not exclusively, to a method and system of liver segmentation.

According to some embodiments of the present invention there is provided a method and a system for segmenting a liver depicted in a medical image, such as a CT or magnetic resonance imager (MRI) image, to a plurality of functionally independent liver segments, for example according to Couinaud classification. The method is based on receiving a medical image depicting the liver parenchyma and separating the liver parenchyma from other organs which are depicted in the medical image. Now the depicted liver parenchyma is segmented, optionally automatically, to functionally independent liver segments. Optionally, the segmentation is performed by computing a plurality of planes passing through the liver parenchyma. Optionally, the planes includes a latitudinal plane that passes through a bifurcation of the intrahepatic portal vein, three vertical planes passing through an axis traversing the inferior vena cava (IVC) and one of the Intrahepatic main hepatic veins, and an additional plane passing through the IVC axis and the bifurcation.

Such segmentation may allow associating a pathological region in the depicted liver, such as a region of tumor, with one or more of the functionally independent liver segments. In such a manner, functionally independent liver segments may be separately marked, presented, and/or forwarded for diagnosis, for example to a computer added diagnosis (CAD) system or reporting system.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

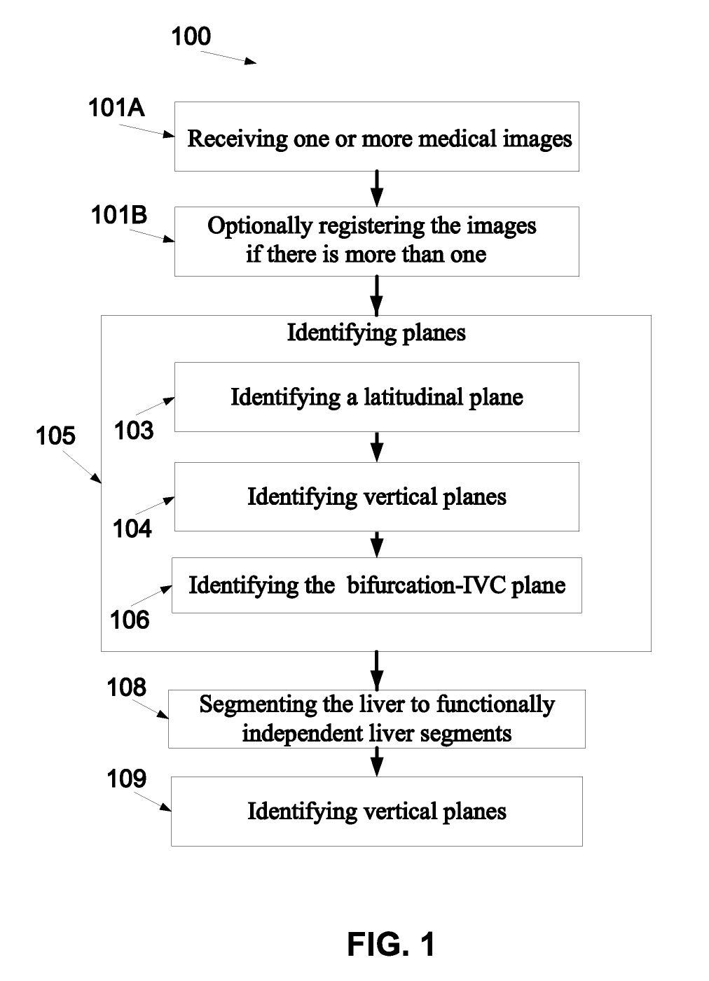

Reference is now made to FIG. 1, which is a flowchart of a method 100 for segmenting liver parenchyma depicted in a medical image to a plurality of functionally independent liver segments, according to some embodiments of the present invention.

First, as shown at 101A, one or more medical images that depicts the liver is received. As used herein, a medical image means a medical image, such as a computed tomography (CT) scan object, a positron emission tomography (PET)/CT scan object, a digital imaging and communications in medicine (DICOM) object, and/or any other medical image. Optionally, the medical image depicts an organ during a defined phase, for example a scan of the liver during the early vein phase or the late portal phase. Optionally, the slices from the defined phase are selected, manually or automatically. Such a medical image may include approximately 300 slices. It should be noted that any other medical scan may also be processed as described herein.

In some embodiments of the invention, a combination of two or more medical images, optionally registered to each other at 101B, is used in method 100 instead of a single medical image, or the combination of registered images may be considered to be the medical image used for method 100. Optionally, the images are acquired at different times. For example, two images acquired at different phases in the same study are used, such as an image acquired during the early vein phase and another image acquired during the late portal phase. Alternatively, images acquired at different times in different studies are used, for examples two images acquired from the same patient a day or a few days apart, a week or a few weeks apart, or a month or a few months apart, possibly showing progressive changes in a lesion. Images made using different modalities may also be used, for example an MRI image and a CT image.

The registration of one image to the other may be made using any method known in the art of registering medical images. For example, mutual information registration may be used, in which a transformation between two images is found which minimizes their joint entropy. Mutual information registration is described, for example, by Josien P. W. Pluim et al, “Mutual-Information-Based Registration of Medical Images: A Survey,” IEEE Trans. Medical Imaging, Vol. 22, No. 8, pp. 986-1004 (August 2003), and by Georgia D. Tourassi et al, “Application of the mutual information criterion for feature selection in computer-aided diagnosis,” Med. Phys., Vol. 28, No. 12, pp. 2394-2402 (December 2001), the disclosures of which are incorporated herein by reference. The registration may be rigid or non-rigid. Non-rigid registration may be advantageous to use if the liver has moved or changed shape between the times when the images were made, due to the patient moving, or due to growth of a tumor over time. If the different images were made at the same time or at nearly the same time, and it is known that the patient has not moved between making the different images, then rigid registration may give more accurate results.

Using two or more images registered to each other has the potential advantage that the resulting segmentation may be more accurate. For example, an image combining two images made during the early vein phase and the late portal phase may show both the portal system and the hepatic veins and IVC better than either image alone, allowing a more accurate determination of the functionally independent liver segments. Using a combination of an MRI image and a CT image has the potential advantage that segmenting the liver from the surrounding tissue may be easier to perform, or more accurate, in an MRI image, while segmenting the functionally independent liver segments may be more easily done, or more accurate, using a CT image. Another potential advantage of using combined images of different modalities, such as MRI and CT, is that the output of the segmentation may be readily displayed on an image of either modality, since the images of different modalities are already registered to each other.

In some embodiments of the invention, two or more images of the liver are acquired, but they are not registered to each other, at least not before segmenting the liver and its functionally independent segments. For example, one image is used to segment the liver and its functionally independent segments, and one or more additional images are used to verify the segmentation results found with the first image. Optionally, in this case, the one or more additional images are registered to the first image with the help of the segmentation results found using the first image, and are then used to verify the segmentation results, or to transfer the segmentation results to the one or more additional images.

Now, as shown at 102, the liver parenchyma is separated from other objects, such as organs, depicted in the received medical image. Various methods may be used for segmenting the liver. Optionally, the body of the patient is initially separated from the background. The separation may include identifying and segmenting a volume of interest (VOI) that encompasses the body of the patient imaged in the medical image, for example using the registration and manipulation method that is described in international patent application publication number WO/2008/062415 filed on Nov. 22, 2007, which is incorporated herein by reference. The registration and manipulation method allows removing and/or otherwise separating objects which are not part of depicted human body, such as a scanner bed, tubes, medical devices and wires, from the imaged tissues in the medical image. Then, the initial objects in the body image, for example fat tissue, muscle layer, organs, and skeleton are refined based on their estimated volume and Hounsfield scale intensity. Now, the lungs are classified as the objects with maximal volume on the left and right sides of the body. Adjacent to the right lung, the gall bladder may be segmented. In combination with the skeleton, this provides further constraints for the liver. The skeleton, the lungs, and the gall bladder may be segmented as described in U.S. Patent Application No. 61/117,586, filed on Nov. 25, 2008, which is incorporated herein by reference. Now, the liver is located below the right lung and is demarcated by the gall bladder and the skeleton, optionally the ribcage. Optionally, the liver is identified as the objected with the maximal volume besides the lungs.

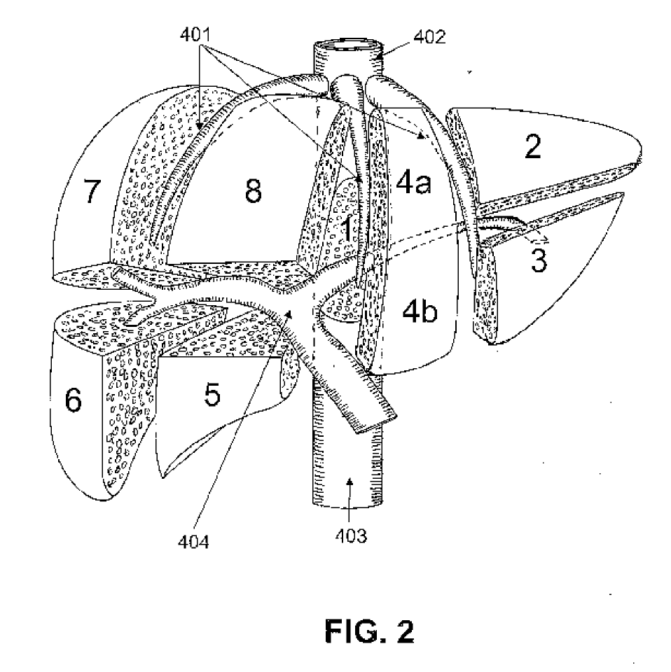

Now, as shown at 105, a plurality of planes passing through the liver parenchyma are identified. Blocks 103, 104, and 106 describe an optional planes identification process. As further described below, the identification is based on reference points and/or axes. Reference is now also made to FIG. 2, which is a schematic illustration of functionally independent liver segments of the liver, optionally as defined according to Couinaud classification. The schematic illustration further describes a number of points of interest which are manually or automatically identified during the segmentation process.

Now, as shown at 103, a latitudinal plane that passes through the intrahepatic portal system is defined. This latitudinal plane divides the liver into upper and lower segment portions. For clarity, a latitudinal plane means a plane that is substantially parallel to the transverse/axial plane of the body depicted in the received medical image.

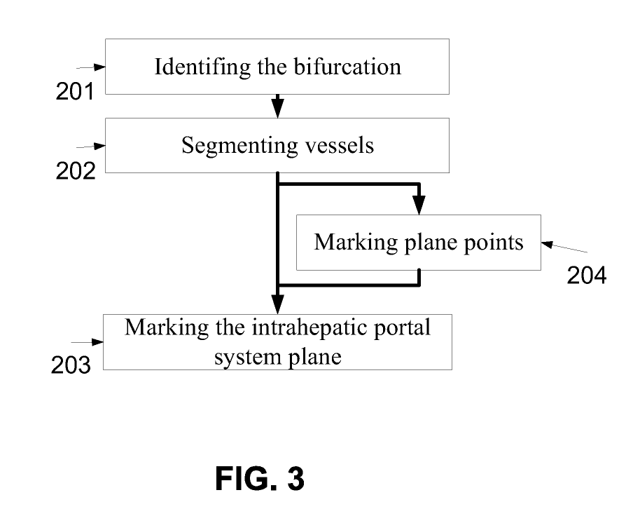

Reference is also made to FIG. 3, which is a flowchart of a process for defining a latitudinal plane traversing the intrahepatic portal system, according to some embodiments of the present invention. First, as shown at 201, a seeding point 404 on the bifurcation of the intrahepatic portal system is identified. Optionally, the seeding point 404 is manually indicated by an operator. In another embodiment, the portal system bifurcation is identified by matching a model of the intrahepatic portal, such as a statistical model, thereto. Optionally, the portal system is automatically detected by applying an atlas registration algorithm, for example as described in U.S. patent application Ser. No. 12/783,590, filed on May 20, 2010, or in U.S. Patent Application Publication 2010-0128953-A1, the dislosures of which are incorporated herein by reference. The atlas registration allows applying an automatic vessel segmentation algorithm, for example as described in U.S. patent application Ser. No. 12/781,836, filed on May 18, 2010, and incorporated herein by reference, in order to detect the abdominal arteries. Then, excluding all the identified arteries, a vessel classifier filter is applied in the same region in which the abdominal arteries are located. The vessel classifier is configured to detect thick tubular vessels, which are not connected to the aorta and have roughly horizontal (x-axis) orientation. These vessels are expanded to the right side of the imaged body, initially until they reach the liver. The point where the vessels reach the liver may be determined, for example, by repeatedly checking the density of background tissue adjacent to the front of the expansion, as the expansion proceeds. When the density of background tissue reaches a density typical of liver tissue, for example between 40 and 60 Hounsfield units, then it is assumed that the vessel expansion has reached the liver, and the expansion is continued inside the liver. Then, of these vessels, the vessel that best fits a model of a bifurcating vessel inside the liver mass is selected as the hepatic system root. Optionally, the bifurcations are identified according to the shape of the probed objects, for example as described in U.S. Patent Application Publication 2010-0128954-A1, incorporated herein by reference.

Now, as shown at 202, at least a portion of the plexus of vessels of the intrahepatic portal system is identified and marked. Optionally, only a set comprising the first branches of the plexus is selected.

Optionally, the portion is identified using a vessel segmentation process, for example as described in U.S. Patent Application 61/179,386, filed on May 19, 2009, which is incorporated herein by reference.

Now, as shown at 203, a latitudinal plane passing through the intrahepatic portal system is calculated. As shown at 204, user inputs may be used in case the vessel segmentation process fails and/or in order to refine the plane calculation, as shown at 204. In such an embodiment, the user marks the main intrahepatic portal veins, for example by selecting one or more points on each intrahepatic portal vein. The two plane points together with the bifurcation point define the latitudinal plane through the intrahepatic portal system. The user inputs may be provided by any man machine interface (MMI), such as a keyboard, a mouse pointer, a touch screen, and/or any device that allows the user to mark points on a display of the separated liver.

Reference is now made, once again, to FIG. 1. As shown at 104, three vertical planes are identified. Each plane passes through one of the right, middle, and left intrahepatic main hepatic veins 401 and through the axis of the inferior vena cava (IVC) 403. For clarity, a vertical plane means a plane that is substantially perpendicular to the latitudinal plane. The right hepatic vein divides the right lobe of the liver into anterior and posterior segments. The middle hepatic vein divides the liver into right and left lobes on a plane that runs from the IVC to the gallbladder fossa. The left hepatic vein divides the left lobe into a medial and lateral part.

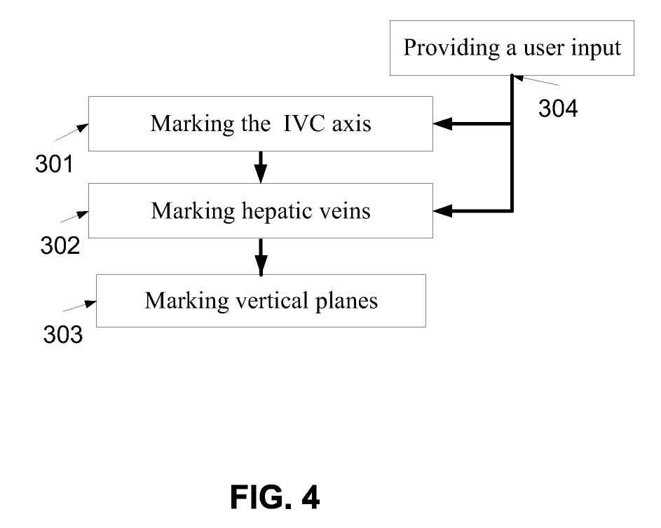

Reference is now also made to FIG. 4, which is a flowchart of a method for identifying the vertical planes, according to some embodiments of the present invention.

First, as shown at 301, the IVC axis is identified and marked. Optionally, a point on the IVC is manually selected, for example the entrance portal 402 of the hepatic veins into the IVC. The point may be manually selected by the user and/or automatically identified according to a match to model, such as a statistical model, of the entrance portal.

Optionally, the IVC axis may be detected automatically according to its anatomy. The IVC flows into the right atrium. Using the algorithm described in Yefeng Zhenget al., “Fast Automatic Heart Chamber Segmentation from 3D CT Data Using Marginal Space Learning and Steerable Features,” Computer Vision, ICCV 2007. IEEE 11th International Conference on Volume, Issue, 14-21 Oct. 2007, Page(s):1-8, which is incorporated herein by reference, the right atrium may be detected. Then, a fast marching algorithm is used, with a seed in the right atrium for tracking the IVC downwards. The IVC is the only thick tubular shape that is roughly parallel to the body axis. This may be detected during fast marching, for example as described in U.S. Pat. No. 61/117,586 filed on Nov. 25, 2008 and incorporated herein by reference. The IVC axis is located by identifying the section in which the shape ceases to be a simple tube, and trifurcates.

Now, as shown at 302, the three main hepatic veins and the IVC are marked, for example using the vessel segmentation process described in U.S. Patent Application 61/179,386, filed on May 19, 2009, which is incorporated herein by reference. The seed of the vessel segmentation process is optionally the entrance portal 402.

Now, as shown at 303, after the segmentation process is successfully completed, three vertical planes 401 are constructed, each through the axis of the IVC and through one of the 3 main hepatic veins.

As shown at 304, a user input, such as a manual selection of the user, may be used for identifying the axis of the IVC. Optionally, the user marks one or more points on the IVC's axis and the IVC axis 403 is calculated accordingly, for example in combination with the orientation of other reference points.

Additionally or alternatively, as shown at 304, the three main hepatic veins are manually selected by the user. For example, the user may mark three or more points, one on each one of the main hepatic veins. These points allow calculating three vertical planes passing through a point on the vein and on the axis of the IVC.

Now, as shown at 303, each one of the vertical planes, constructed through the IVC axis and through one of the hepatic veins, is marked.

Reference is now made, once again, to FIG. 1. Optionally, as shown at 105, a plane passing through the IVC axis 403 and through the seeding point 404 of the bifurcation of the intrahepatic portal system, which is optionally identified as described in 201, is calculated. This plane may be referred to herein as the bifurcation-IVC plane.

The planes calculated in 105 allow segmenting the separated liver into functionally independent liver segments, for example, according to the Couinaud classification, as shown at 108. The three vertical planes 401, the plane calculated in 105, and the latitudinal plane 402 divide the liver's space to 8 functionally independent liver segments. Segments 2, 3, 4A, 4B, 5, 6, 7, and 8 are marked in FIG. 2 according to their name. Segment 1, also known as the caudate lobe, is identified according to the orientation of the plane passing through the IVC axis 403 and through the seeding point 404 of the bifurcation of the Intrahepatic portal system, as described in 303.

As commonly known, each one of the 8 functionally independent liver segments has its own vascular inflow, outflow and biliary drainage. In the center of each segment there is a branch of the portal vein, hepatic artery and bile duct and in the periphery of each segment there is vascular outflow through the hepatic veins. The segmentation allows attributing a certain pathological region, such as a region of tumor, to the functionally independent liver segments in which it is located. Such identification may be used for marking and presenting the functionally independent liver segments, for example on a display of a client terminal, such as a computer, a laptop and a Smartphone. The marking may assist the surgeon and/or any other caretaker to operate on one or more functionally independent liver segments, for example to surgically remove them, without damaging the remaining functionally independent liver segments. Additionally or alternatively, the marking may assist in calculating a remaining and/or a dissected volume of a liver that is resected for transplantation denotation.

Optionally, the user may manually adjust the segmentation. For example, segment 1 may be adjusted by allowing the user to select one or more points on its estimated boundary and/or on the plane of the ligamentum venosum split. The planes dividing segment 1 may now be reconstructed through the one or more selected points which are provided by the user.

Now, as shown at 109, the segmentation of the eight functionally independent segments of the liver is outputted, facilitating the diagnosis of the liver by a physician, for example a radiologist and/or a CAD system.

It is expected that during the life of a patent maturing from this application many relevant systems and methods will be developed and the scope of the term a medical image and a CAD system is intended to include all such new technologies a priori.

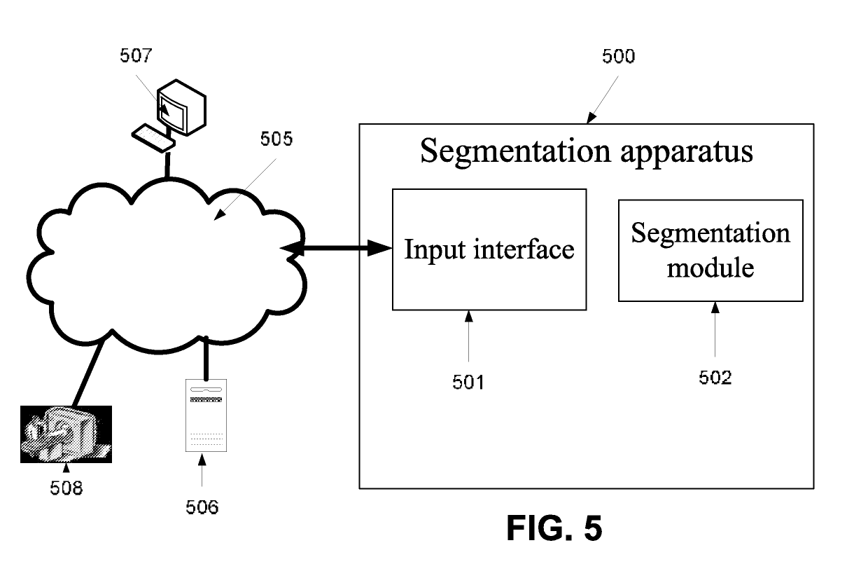

Reference is now also made to FIG. 5, which is a schematic illustration of an apparatus 500 connected to a communication network 505, such as the internet, for segmenting the liver in medical studies to eight functionally independent liver segments, for example according to the method depicted in FIG. 1, according to some embodiments of the present invention. The apparatus comprises an input interface 501 configured for receiving a medical image, such as a CT study of the liver. The input interface 501 optionally receives the medical image from remote medical databases 506, an imaging modality 508, and/or a remote client terminal 507, for example as described in Provisional U.S. Patent Applications No. 61/071,709 and Patent application No. 61/071,708 both co-filed on May 14, 2008, which the content of which is hereby incorporated by reference. The apparatus 500 further comprises a segmentation module 502 for segmenting the liver in the received medical image, for example as described above in relation to FIG. 1. Optionally, the segmentation described hereinabove may be used for segmenting medical studies in a medical database 506, such as the PACS. Such an application may be activated automatically and/or according to user inputs (UI), such as UI received via a directed graphical user interface (GUI). The user inputs allow a user to select a VOI, such as the liver, in a medical image. Such a selection may used for linking the user to data related to the functionally independent liver segments, changing the presentation of the functionally independent liver segments, notifying the system that these functionally independent liver segments have been probed, and/or adding an analysis related to the functionally independent liver segments and/or a related organ that has been probed. Additionally or alternatively, such segmentation allows integrating a PACS into an external anatomy and pathology databases that is based on the functionally independent liver segments. The user clicks on the functionally independent liver segments and the relevant information from the PACS database is displayed.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, an and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method for segmenting liver parenchyma in a medical image, comprising:
a) receiving a medical image depicting the liver parenchyma;
b) separating the liver parenchyma from at least one object depicted in said medical image; and
c) segmenting the depicted liver parenchyma to a plurality of functionally independent liver segments.

2. The method of claim 1, further comprising computing a plurality of planes passing through the liver parenchyma, said segmenting being performed according to said plurality of planes.

3. The method of claim 2, wherein said segmenting is performed automatically according to said plurality of planes.

4. The method of claim 2, wherein said computing comprises:
1) identifying a latitudinal plane passing through a bifurcation of the liver parenchyma;
2) identifying three vertical planes each passing through an axis traversing the inferior vena cava (IVC) and one of the intrahepatic main hepatic veins; and
3) identifying an additional plane passing through said axis and said bifurcation; wherein said segmenting is performed according to a combination of said latitudinal plane, said three vertical planes, and said additional plane.

5. The method of claim 4, wherein automatically identifying comprises allowing a user to mark at least one point on said bifurcation using a user interface and performing said identifying according to said at least one point.

6. The method of claim 4, wherein identifying a latitudinal plane comprises allowing a user to mark at least one point on said bifurcation using a user interface and performing said identifying according to said at least one point.

7. The method of claim 2, wherein said computing comprises segmenting at least a portion of a plexus of vessels of the intrahepatic portal system of the liver parenchyma and identifying at least one of said plurality of planes according to said portion.

8. The method of claim 2, wherein said computing is performed automatically.

9. The method of claim 1, further comprising allowing a user to refine said segmenting using a user interface.

10. The method of claim 1, wherein said medical image is selected from a group consisting of a computed tomography (CT) scan object, a positron emission tomography (PET)/CT scan object, and a digital imaging and communications in medicine (DICOM) object.

11. The method of claim 1, further comprising presenting said functionally independent liver segments.

12. The method of claim 1, further comprising forwarding the segmentation of said functionally independent liver segments to a computing unit to allow a diagnosis of at least one of said functionally independent liver segments.

13. The method of claim 1, further comprising identifying a pathological region in the liver parenchyma and associating said pathological region with at least one of said functionally independent liver segments.

14. The method of claim 1, further comprising receiving at least one additional medical image depicting the liver parenchyma, wherein separating the liver parenchyma, or segmenting the liver parenchyma into functionally independent liver segments, or both, is done using data from more than one of the medical images.

15. A method according to claim 14, wherein at least two of the medical images are acquired at different times.

16. A method according to claim 15, wherein at least two of the medical images are acquired at different phases of a same study of the liver.

17. A method according to claim 15, wherein at least two of the medical images are acquired in different studies of the liver of a same patient.

18. A method according to claim 14, wherein at least two of the medical images are made using different modalities.

19. A method according to claim 18, where at least one of the medical images is a CT image.

20. A method according to claim 18, where at least one of the medical images is an MRI image.

21. A method according to claim 14, also including registering the medical image to the at least one additional medical image, before at least one of separating the liver parenchyma and segmenting the liver parenchyma into functionally independent segments.

22. An apparatus for segmenting liver parenchyma in a medical image, comprising:
an input interface for receiving a medical image depicting the liver parenchyma; and
a segmentation module for computing a segmentation of the depicted liver parenchyma to a plurality of functionally independent liver segments.

23. The apparatus of claim 22, wherein said segmentation module is configured for identifying a plurality of planes passing through the depicted liver and performing said segmentation according to said plurality of planes.

24. The apparatus of claim 22, further comprising a user interface for allowing a user to refine said segmenting.

25. The apparatus of claim 22, further comprising a user interface for allowing a user to mark at least one reference point on said liver parenchyma, said segmentation module configured for receiving said at least one reference point and generating said segmentation accordingly.

26. The apparatus of claim 22, wherein said input interface is configured for receiving said medical image from an archiving communication system (PACS).

27. The apparatus of claim 22, wherein said medical image is selected from a group consisting of a computed tomography (CT) scan object, a positron emission tomography (PET)/CT scan object, and a digital imaging and communications in medicine (DICOM) object.

28. The apparatus of claim 22, further comprising an output unit for separately outputting at least one of said functionally independent liver segments.

29. The apparatus of claim 22, wherein said segmentation module separating the liver parenchyma from at least one object depicted in said medical image and performing said identification accordingly.

30. The apparatus of claim 22, wherein said segmentation module segmenting at least a portion of a plexus of vessels of the intrahepatic portal system of the liver parenchyma and performing said identification accordingly.

31. The apparatus of claim 22, wherein said input interface is configured for receiving said medical image from a remote terminal via a communication network.
